(19) United States
(12) Patent Application Publication
(10) Pub. No.: US 2003/0005570 A1
(43) Pub. Date: Jan. 9, 2003

(54) Method of fabricating an electrical core sheet assembly of circular cross section

(76) Inventor: Benjamin Weber, Winterberg (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/190,121

(22) Filed: Jul. 3, 2002

(30) Foreign Application Priority Data
Jul. 5, 2001 (DE) 101 32 716.1

(51) Int. Cl. H01F 7/06; H01F 3/00

(52) U.S. Cl. 29/602.1; 29/417; 29/604

(57) ABSTRACT

An electrical core-sheet assembly of circular cross section, such as a transformer leg, is formed from a stack of core sheets. First, a roll of a strip of core-sheet material is unwound and cut up into at least two sheet strips. The width of each sheet strip varies infinitely from a predetermined minimum value to a predetermined maximum value. The core sheets required for forming the electrical core sheet assembly are subsequently cut progressing in the longitudinal direction of the sheet strips, taking into account the shape at the ends. Finally, to form the electrical core-sheet assembly of circular cross section, the cut core sheets are stacked one on top of the other in the order in which they are cut from the minimum value to the maximum value and from the maximum value to the minimum value.

### BACKGROUND OF THE INVENTION

### FIELD OF THE INVENTION

The invention relates to a method of fabricating an electrical core sheet assembly of circular cross section. The invention can be used, for example, for forming transformer legs of transformer cores.

To produce a transformer leg of circular cross section, it is possible for example to produce a straight sheet strip, the width of the sheet strip corresponding to the length of the transformer leg to be formed. The individual core sheets (also referred to as core plates) of different, graduated widths can then be cut out of the sheet strip. The core sheets, stacked one on top of the other in the order in which they are cut, produce the transformer leg of the desired circular cross section. It is disadvantageous in this case that a grain-oriented sheet, which has a preferred direction of magnetization in the longitudinal direction of rolling, and consequently leads advantageously to a reduction in power loss during operation, cannot be used. This method could be used, for example, for inductors.

### SUMMARY OF THE INVENTION

It is accordingly an object of the invention to provide a method of fabricating an electrical core sheet assembly with a circular cross section, which overcomes the above-mentioned disadvantages of the heretofore-known devices and methods of this general type and which is suitable for the production of electrically optimized core-sheet assemblies.

With the foregoing and other objects in view there is provided, in accordance with the invention, a method of fabricating an electrical core sheet assembly of circular cross section, such as a transformer leg. The method comprises the following method steps:

unwinding a roll of strip of core sheet material and cutting the material into at least two sheet strips each having a width steplessly varying from a predetermined minimum value to a predetermined maximum value;

subsequently cutting the sheet strips into core sheets required for forming the electrical core sheet assembly, taking into account a shape of the core sheets at ends thereof;

subsequently stacking the cut core sheets on top of one another in an order in which the core sheets are cut from the minimum value to the maximum value and from the maximum value to the minimum value, to thereby form the electrical core sheet assembly of circular cross section.

In accordance with an added feature of the invention, the cutting step comprises cutting sequentially in a longitudinal direction of the sheet strips.

In accordance with a concomitant feature of the invention, two half core sheet assemblies are placed together such that the core sheets taper from bottom to top in one half and from top to bottom in the other half.

The advantages which can be achieved by the invention are, in particular, that the individual core sheets can be cut off in the longitudinal direction of the roll of strip consisting of a grain-oriented material, whereby the direction of magnetization within the core-sheet assembly runs in the longitudinal direction of the grain orientation of the roll of strip. This results in an optimization (reduction) with regard to the power loss produced by the transformer core during operation. The utilization factor (ratio between the actual cross-sectional area of the core-sheet assembly and the area of the smallest-possible circle around the cross section of the core-sheet assembly) is naturally very high in the case of a core-sheet assembly of circular cross section—in particular when core sheets of small thickness and relatively fine graduation of the widths of successive core sheets are used.

In the case of the proposal according to the invention, there is no increase in the required production time for the fabrication of the core-sheet assembly in comparison with a core-sheet assembly of square cross section or roughly graduated cross section. By contrast, on account of the necessary changes of different sheet widths, the fabrication time for a roughly graduated core is to be put even higher than that of the core produced according to the invention. At the same time, the core-sheet material is very well utilized, i.e. there is only a relatively small amount of scrap (wastage) of sheet, caused exclusively by the shaping of the ends of the core-sheet assembly.

Other features which are considered as characteristic for the invention are set forth in the appended claims.

Although the invention is illustrated and described herein as embodied in a method of fabricating an electrical core-sheet assembly of circular cross section, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a view of an L-shaped transformer core;

FIG. 2 is a cross section through a transformer leg; and

FIG. 3 shows a view of a detail of an unwound roll of strip material.

### DESCRIPTION OF THE PREFERRED EMBODIMENTS

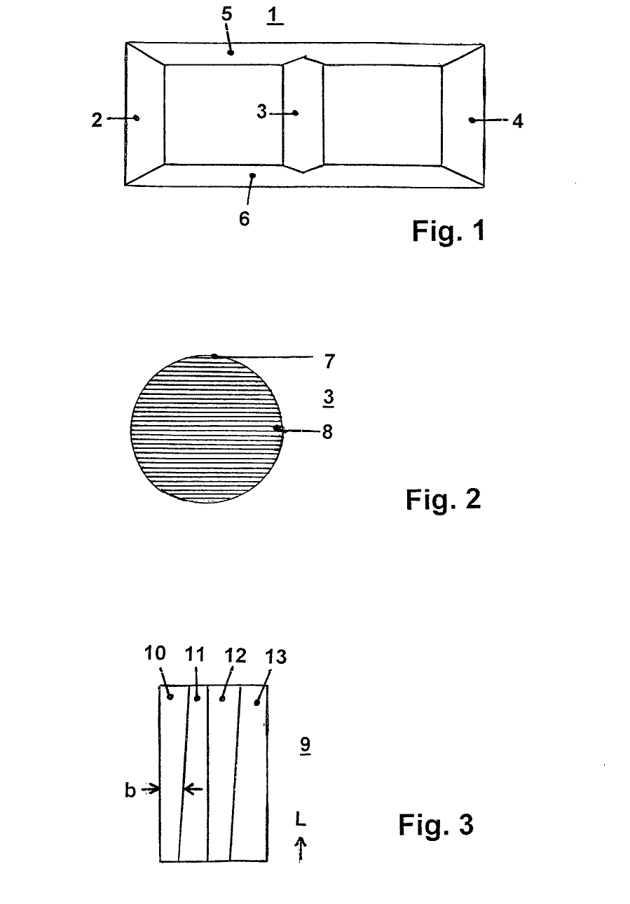

Referring now to the figures of the drawing in detail and first, particularly, to FIG. 1 thereof, there is shown a transformer core (L-shaped). The transformer core 1 has, as core-sheet assemblies, three transformer legs 2, 3, 4 and also two transformer yokes 5, 6. The connecting joints between transformer legs 2, 3, 4 and transformer yokes 5, 6 are beveled in each case, so that an optimum guidance of the magnetic flux is also obtained in the transitional region between a transformer leg and a transformer yoke, and consequently a minimization of the power loss produced during the operation of the transformer core 1. The type of beveling depends on whether the transformer leg concerned is to be arranged in the middle or at the edge of an L transformer core.

In FIG. 2, a cross section through a transformer leg—in the example transformer leg 3—is represented. The transformer leg 3, made up of numerous core sheets, has a circular cross section. This is achieved by the width of the core sheets stacked one on top of the other being varied in relatively fine graduation. In FIG. 2, a relatively narrow core sheet 7 (also referred to hereafter as “minimum value”), arranged on the outer side of the transformer leg, and a relatively wide core sheet 8 (hereinafter also referred to as “maximum value”), arranged at the center of the transformer leg, are designated. The width of the further core sheets lies between these two limit values.

In FIG. 3, a view of an unwound roll of strip (detail) is represented. This is a grain-oriented sheet, which has the property of having much smaller losses when magnetized in the longitudinal direction (see longitudinal axis L) than when magnetized in the transverse direction (perpendicular to L). The possible dimensions of the unwound roll of strip 9 are, for example, 1 m width and several hundred m length. The roll of strip 9 is subdivided in the direction of its longitudinal axis L into four individual sheet strips 10, 11, 12, 13 (cut up), the width b of each sheet strip being varied steplessly in the longitudinal direction from a minimum value to a maximum value. After the cutting of the unwound roll of strip 9, the individual sheet strips 10, 11, 12, 13 are preferably rolled up again and can then be cut in an automated core-cutting installation to form the required core sheets. By putting the cut core sheets together, the desired core-sheet assemblies are then fabricated.

A sheet strip 10, 11, 12, 13 in this case comprises all the core sheets required for half a transformer leg, from the outer narrow core sheet 7 to the wide central core sheet 8, so that all the core sheets required for forming a transformer leg are cut out from two sheet strips. If the length of a sheet strip is not adequate for half a transformer leg, it is necessary to cut a further sheet strip, the initial width of which corresponds to the end width of the first sheet strip. The width variation in the case of the sheet strips 10, 11, 12, 13 must be chosen such that core sheets cut one behind the other in the longitudinal direction (see L) of the sheet strip (from the minimum value to the maximum value and from the maximum value to the minimum value) lead to a circular cross section of the transformer leg when they are subsequently stacked one on top of the other. The respectively cut-off core sheets are substantially all the same length, this length corresponding to the length of the transformer leg. The shape of the end regions of the individual core sheets differs, however, because of the bevels already mentioned in respect of FIG. 1, which is taken into account during the automated cutting process of the core-cutting installation.

A transformer leg made up of the core sheets does not have an ideal cylindrical form, but a slightly conical shape. To make the core cross sections at the two ends of a transformer similar, two half transformer legs can be put together in such a way that the core sheets taper from bottom to top in the case of one half and from top to bottom in the case of the other half.

I claim:

1. A method of fabricating an electrical core sheet assembly, of circular cross section, which comprises:
unwinding a roll of strip of core sheet material and cutting the material into at least two sheet strips each having a width steplessly varying from a predetermined minimum value to a predetermined maximum value;
subsequently cutting the sheet strips into core sheets required for forming the electrical core sheet assembly, taking into account a shape of the core sheets at ends thereof;
subsequently stacking the cut core sheets on top of one another in an order in which the core sheets are cut from the minimum value to the maximum value and from the maximum value to the minimum value, to thereby form the electrical core sheet assembly of circular cross section.

2. The method according to claim 1, which comprises stacking the core sheets to form a transformer leg.

3. The method according to claim 1, wherein the cutting step comprises cutting sequentially in a longitudinal direction of the sheet strips.

4. The method according to claim 1, which comprises stacking two half core sheet assemblies together such that the core sheets taper from bottom to top in one half and from top to bottom in the other half.
